(19) United States
(12) Patent Application Publication
(10) Pub. No.: US 2024/0092347 A1
(43) Pub. Date: Mar. 21, 2024

(54) PARKING ASSISTANCE APPARATUS AND PARKING ASSISTANCE METHOD

(71) Applicant: Panasonic Intellectual Property Management Co., Ltd., Osaka (JP)

(72) Inventor: Satoshi FUKUMOTO, Tokyo (JP)

(73) Assignee: Panasonic Intellectual Property Management Co., Ltd., Osaka (JP)

(21) Appl. No.: 18/367,005

(22) Filed: Sep. 12, 2023

(30) Foreign Application Priority Data
Sep. 16, 2022 (JP) 2022-148062

(51) Int. Cl. B60W 30/06; B60W 50/14

(52) U.S. Cl. CPC B60W 30/06; B60W 50/14; B60W 2050/146

(57) ABSTRACT

Provided is a parking assistance apparatus that performs parking assistance based on a training route of a vehicle in training traveling. The parking assistance apparatus includes a processor that determines whether a current position of the vehicle is outside the training route based on the current position of the vehicle and the training route. The processor outputs, in a case where the current position of the vehicle is outside the training route, a command to notify an occupant in the vehicle.

### TECHNICAL FIELD

The present disclosure relates to a parking assistance apparatus and a parking assistance method.

### BACKGROUND ART

As one parking assistance for a vehicle, there is known a technique of storing a traveling route based on training traveling by a driver and performing parking assistance of automatic parking based on the stored traveling route. For example, Patent Literature (hereinafter referred to as “PTL”) 1 discloses a configuration in which a parking route that merges into a stored reference route is determined.

### CITATION LIST

### Patent Literature

### PTL 1

Japanese Patent No. 6022447

### SUMMARY OF INVENTION

### Technical Problem

### Solution to Problem

A parking assistance apparatus according to the present disclosure is a parking assistance apparatus that performs parking assistance based on a training route of a vehicle in training traveling. The parking assistance apparatus includes a processor that determines whether a current position of the vehicle is outside the training route based on the current position of the vehicle and the training route. The processor outputs, in a case where the current position of the vehicle is outside the training route, a command to notify an occupant in the vehicle.

A parking assistance method according to the present disclosure is a parking assistance method of a parking assistance apparatus that performs parking assistance based on a training route of a vehicle in training traveling. The parking assistance method includes: determining whether a current position of the vehicle is outside the training route based on the current position of the vehicle and the training route; and outputting, in a case where the current position of the vehicle is outside the training route, a command to notify an occupant in the vehicle.

### Advantageous Effects of Invention

According to the present disclosure, it is possible to improve a feeling of security of an occupant in a vehicle in automatic parking control.

### BRIEF DESCRIPTION OF DRAWINGS

FIG. 1 illustrates a vehicle including a parking assistance apparatus according to an embodiment of the present disclosure;

FIG. 2 illustrates an example of a display example on a display;

FIG. 3 is a flowchart illustrating an operation example of notification command output control during automatic traveling control in the parking assistance apparatus;

FIG. 4A illustrates a display example of an object around a route to be traveled on the display;

FIG. 4B illustrates an example of emphasized display of the object in FIG. 4A;

FIG. 5A illustrates a display example of an object around a training route on the display; and

FIG. 5B illustrates an example in which the object in FIG. 5A is displayed by lowering a degree of attention calling.

### DESCRIPTION OF EMBODIMENTS

### Embodiment

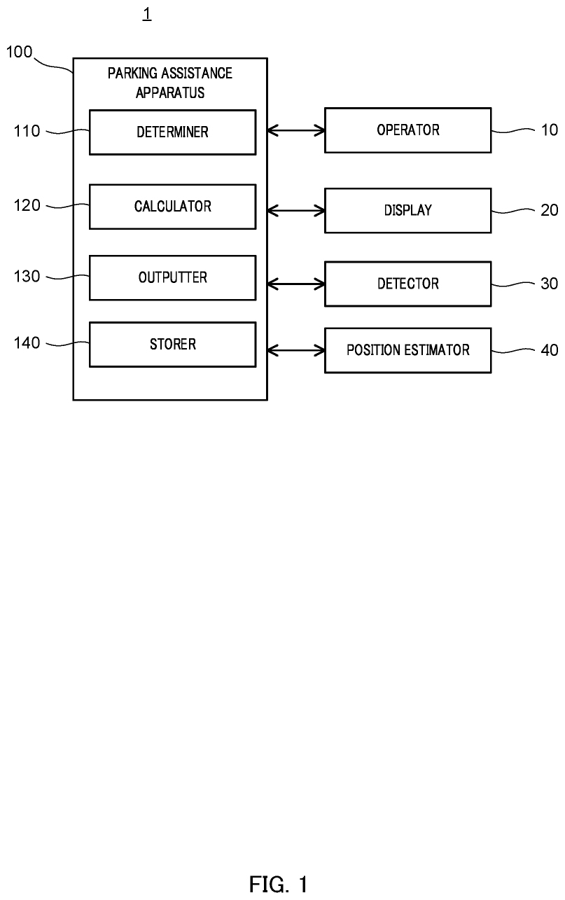

Hereinafter, an embodiment of the present disclosure will be described with reference to the drawings. FIG. 1 illustrates a vehicle including a parking assistance apparatus according to the embodiment of the present disclosure.

As illustrated in FIG. 1, vehicle 1 has the function of automatic parking assistance to perform automatic parking in a predetermined parking space, and includes operator 10, display 20, detector 30, position estimator 40, and parking assistance apparatus 100.

Operator 10 includes a steering wheel, a gas pedal, and the like for the driver (user) to operate vehicle 1. The driving operation of vehicle 1 is an operation related to the driving of vehicle 1, such as a steering operation of vehicle 1, a gas pedal operation of vehicle 1, and a brake operation of vehicle 1, for example.

Display 20 is, for example, a display medium such as automotive navigation apparatus. Display 20 displays, for example, a route to be traveled by vehicle 1, or the like, during automatic parking control in parking assistance apparatus 100.

Detector 30 is a detection apparatus, such as a camera, a radar, and a sonar, that detects an object in the periphery of vehicle 1. The object detected by detector 30 is displayed on, for example, display 20 or the like, during the automatic parking control in parking assistance apparatus 100.

Position estimator 40 is an apparatus (for example, an ECU of vehicle 1 or the like) that estimates a current position of vehicle 1, and estimates the current position of vehicle 1 by using, for example, a publicly known technique based on a detection result(s) of a map information storer (not illustrated) and/or detector 30, or the like.

Parking assistance apparatus 100 is an apparatus that includes a central processing unit (CPU) (not illustrated), a read only memory (ROM) (not illustrated), a random access memory (RAM) (not illustrated), and input-output circuitry (not illustrated), and performs automatic parking control such that automatic parking is performed in a predetermined parking space. Parking assistance apparatus 100 may be incorporated into another apparatus such as, for example, an automotive navigation apparatus.

Parking assistance apparatus 100 includes storer 140, and causes storer 140 to store, as training traveling data, a route when parking is performed in a predetermined parking space by a driving operation of the user, and an operation of operator 10 by the user. Then, vehicle 1 performs control such that automatic parking is performed (automatic parking control) based on the training traveling data when parking is performed next time in the predetermined parking space.

During the automatic parking control, parking assistance apparatus 100 generates a route to be traveled by vehicle 1, on the basis of a current position of vehicle 1 based on an estimation result of position estimator 40, and on the basis of an operation state (such as a steering angle) of operator 10. The generated route is displayed on display 20 or the like.

Further, in a case where a route, which vehicle 1 during the automatic parking control travels, deviates from a training route, which is a route in a training traveling data, parking assistance apparatus 100 controls the traveling of vehicle 1 such that vehicle 1 merges into the training route.

For example, in a case where the start position of the automatic parking control is a position different from the start position in training traveling, a route that vehicle 1 travels after the start of the automatic parking control is a route different from a route of training traveling. For this reason, parking assistance apparatus 100 controls the traveling of vehicle 1 in the automatic parking control such that vehicle 1 gradually approaches and merge into the training route from the route that vehicle 1 is traveling.

The control of parking assistance apparatus 100 such that vehicle 1 merges into a training route from a route that vehicle 1 travels may be control based on an estimation result of a vehicle position by position estimator 40 or the like, for example, publicly known control. Note that, in a case where a route that vehicle 1 during the automatic parking control travels deviates from a training route, the traveling of vehicle 1 may be controlled without vehicle 1 merging into the training route. For example, the control of parking assistance apparatus 100 may be control such that a traveling tube and an area outside a training route that are calculated from a steering angle calculated from a route tracking error to be described later are displayed on display 20 without generating a route to be traveled by vehicle 1.

Further, in a case where a current position of vehicle 1 during the automatic parking control deviates from a training route, parking assistance apparatus 100 notifies attention calling information to an occupant in vehicle 1. Specifically, parking assistance apparatus 100 causes display 20 to perform emphasized display of a portion of a route to be traveled by vehicle 1 during the automatic parking control, where the portion deviates from a training route. Parking assistance apparatus 100 includes determiner 110, calculator 120, and outputter 130.

Determiner 110 determines whether a current position of vehicle 1 is outside a training route based on the current position of vehicle 1 and the training route. More specifically, determiner 110 determines a deviation degree between a current position of vehicle 1 during the automatic parking control and a route of vehicle 1 in training traveling (training route). Specifically, determiner 110 compares a current position of vehicle 1, which is estimated by position estimator 40, with a training route stored as a training traveling data to determine a deviation degree between the current position of vehicle 1 and the training route. Further, determiner 110 may determine whether a route tracking error between a current position of vehicle 1 and a training route is equal to or greater than a predetermined value.

The route tracking error is, for example, a deviation amount between a current position of vehicle 1 estimated by a position estimator 40 and a position of a training route, and may be at least one of a lateral deviation amount and an angle deviation amount.

The predetermined value can be configured to an arbitrary value.

Note that, determiner 110 may determine a deviation degree between a route to be traveled by vehicle 1, which is generated by parking assistance apparatus 100, and a training route based on at least one of a lateral deviation amount and an angle deviation amount.

Calculator 120 calculates, based on a determination result of determiner 110, an area, where emphasized display is performed, in a route to be traveled by vehicle 1.

For example, calculator 120 calculates an area, where emphasized display is performed, in a route to be traveled by vehicle 1 based on a route tracking error determined by determiner 110 and the width of a route that vehicle 1 travels. Specifically, calculator 120 calculates an area of a portion of a route to be traveled by vehicle 1, where the portion deviates from a training route (a portion that does not overlap the training route). In other words, calculator 120 calculates an area in a route to be traveled by vehicle 1, where the area is an area in which vehicle 1 does not travel in training traveling.

In a case where a current position of vehicle 1 is outside a training route, outputter 130 outputs a command to notify an occupant in vehicle 1. More specifically, outputter 130 outputs a command to notify an occupant in vehicle 1 of attention calling information to display 20 based on a determination result of determiner 110. Specifically, outputter 130 outputs, for example, based on information on an area calculated by calculator 120, a command to cause a display medium such as display 20 to display, as attention calling information, information on a route to be traveled by vehicle 1 in the automatic parking control.

The display aspect on the display medium is, for example, an aspect in which a portion of a route to be traveled, where the portion deviates from a training route, is more emphasized than a portion of the route to be traveled, where the portion overlaps the training route.

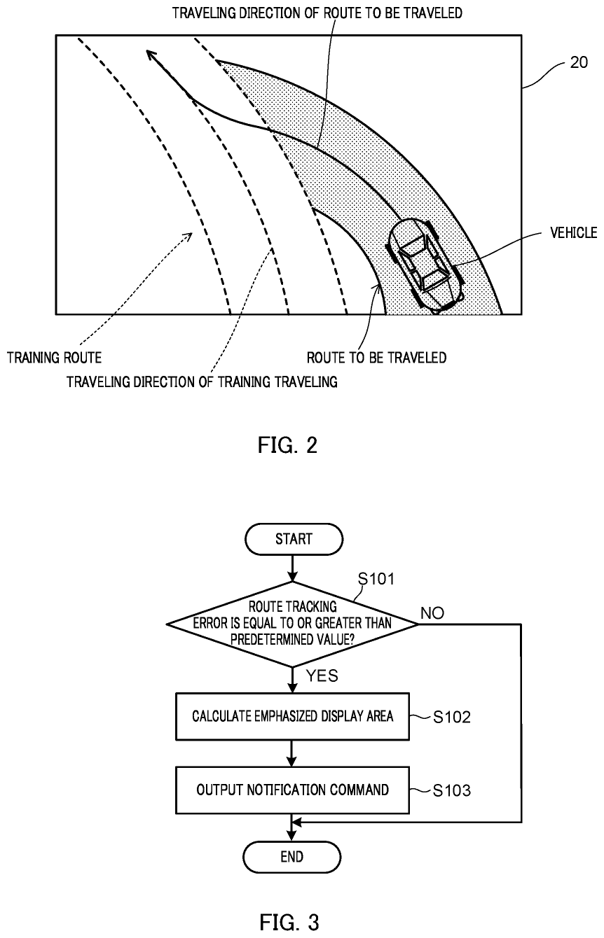

For example, as illustrated in FIG. 2, display 20 displays a route to be traveled by vehicle 1 and a training route, and performs emphasized display of a portion of the route to be traveled, where the portion deviates from the training route. FIG. 2 indicates an example in which the portion of the route to be traveled, where the portion deviates from the training route, is displayed in a colored state.

In this way, an occupant in vehicle 1 can grasp at a glance that a route to be traveled deviates from a route of training traveling.

Note that, the display aspect on the display medium may be any aspect as long as the aspect causes a portion of a route to be traveled, where the portion deviates from a training route, to be more conspicuous than a portion overlapping a training route, which would be immediately noticed by an occupant in vehicle 1, such as an aspect in which the display of a route to be traveled is caused to flicker, and an aspect in which a route to be traveled is caused to be thicker than that prior to a change. Further, although a training route is displayed with broken lines in FIG. 2 or the like, a training route may be displayed in another aspect in which the training route is less conspicuous than a route to be traveled, or no training route may be displayed. Further, in a case where a training route is displayed on display 20, information on a route to be traveled may be displayed on the display medium in an aspect different from information on a training route. The different aspect may be an aspect that causes a route to be traveled to be displayed in a color different from a color of a training route, or an aspect that causes a route to be traveled to be more conspicuous than a training route.

Next, an operation example of parking assistance apparatus 100 will be described. FIG. 3 is a flowchart illustrating an operation example of notification command output control during the automatic traveling control in parking assistance apparatus 100.

As illustrated in FIG. 3, parking assistance apparatus 100 determines whether a route tracking error is equal to or greater than a predetermined value (step S101). In a case where the route tracking error is less than the predetermined value as a result of the determination (step S101, NO), this control ends.

In a case where the route tracking error is equal to or greater than the predetermined value (step S101, YES), on the other hand, parking assistance apparatus 100 calculates an area where emphasized display is performed (step S102). Then, parking assistance apparatus 100 outputs, as a notification command, information on the area where emphasized display is performed, to display 20 (step S103). After step S103, this control ends.

According to the present embodiment configured as described above, it is possible to make it easier for an occupant in a vehicle to notice that a route that the vehicle is traveling deviates from a training route. As a result, it is possible to direct the attention of the occupant in the vehicle during the automatic parking control to the periphery of the vehicle before the vehicle enters a parking space. Accordingly, the automatic parking control is performed while the occupant in the vehicle is caused to confirm safety, and thus, it is possible to improve safety in the automatic parking control and further to cause the occupant in the vehicle to obtain a feeling of security.

Note that, in the embodiment described above, information on an area where emphasized display of a portion of a route to be traveled by vehicle 1, where the portion deviates from a training route, is performed has been exemplified as the attention calling information, but the present disclosure is not limited thereto. For example, the attention calling information may be information on an object located around a traveling route.

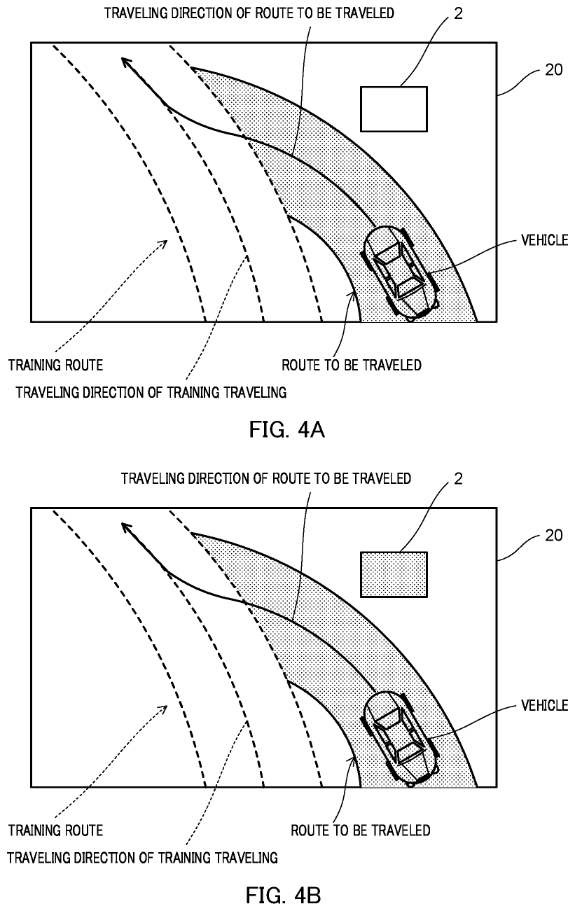

For example, it is assumed that there is object 2 located on a side of a route to be traveled rather than a route of training traveling as illustrated in FIG. 4A.

Although the vehicle at the time of training traveling travels so as to be sufficiently away from object 2, a case where the route to be traveled becomes closer to object 2 than the training route due to, for example, deviation of the start position of the automatic parking control from that at the time of training traveling may occur.

In this case, outputter 130 outputs a command for emphasized display of object 2 to be displayed on display 20 to display 20. That is, outputter 130 causes display 20 to perform emphasized display of, as attention calling information, information on object 2 that is closer to the route to be traveled by vehicle 1 than to the training route in the automatic parking control.

In this way, object 2 is displayed on display 20, for example, in a colored state as illustrated in FIG. 4B.

Thus, it is possible to make it easier for an occupant in vehicle 1 to notice an object present at a position relatively close to a route that vehicle 1 is traveling. As a result, it is possible to improve a feeling of security of the occupant in vehicle 1 in the automatic parking control.

Further, the emphasized display aspect may be any aspect as long as the aspect causes object 2 to be more conspicuous than that prior to a change, which would be immediately noticed by an occupant in vehicle 1, such as an aspect in which the display of object 2 is caused to flicker, and an aspect in which object 2 is caused to be thicker than that prior to a change.

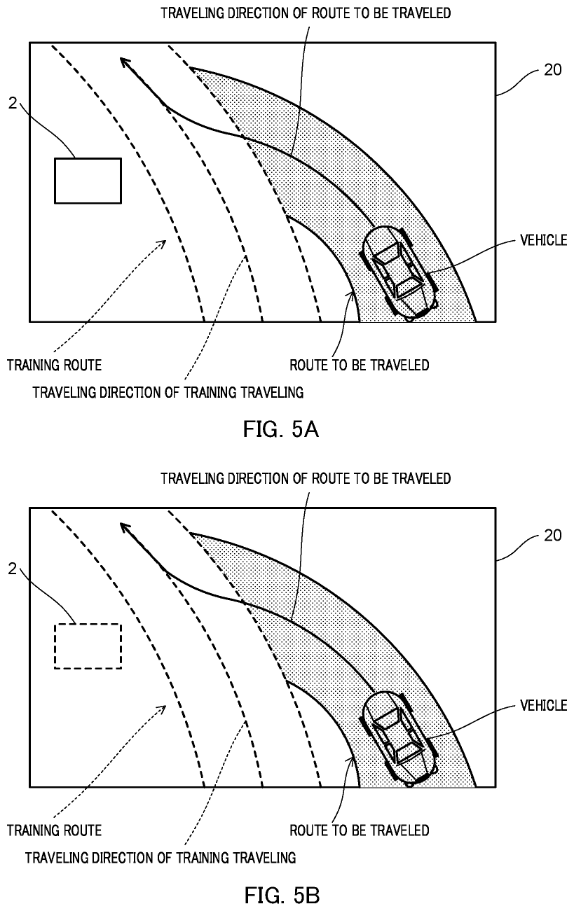

Further, as illustrated in FIG. 5A, in a case where a route to be traveled deviates to an opposite side of object 2, which is located around a training route, with respect to the training route, vehicle 1 and object 2 are more separated from each other than when vehicle 1 travels on the training route. In this case, it is considered that the degree of attention directed to object 2 may be lowered for an occupant in vehicle 1.

For this reason, outputter 130 may output, to display 20, a command to lower the degree of attention calling to information on object 2, which is closer to a training route than to a route to be traveled by vehicle 1 in the automatic parking control, than the degree of attention calling prior to a change.

In this way, object 2 is displayed on display 20, for example, in a state of a broken line as illustrated in FIG. 5B.

Since an object closer to a training route than to a route to be traveled is an object to which attention is relatively less required to be directed, displaying such an object inconspicuously makes it possible to direct the attention of an occupant in vehicle 1 to a location closer to a route that vehicle 1 is traveling with respect to the route of training traveling. As a result, it is possible to improve a feeling of security of the occupant in vehicle 1 in the automatic parking control.

Further, the aspect of lowering the degree of attention calling may be any aspect as long as the aspect causes the display of object 2 to be more inconspicuous than that prior to a change, such as an aspect in which the display of object 2 is caused to be thinner than that prior to a change.

Further, in the embodiment described above, determiner 110 determines a deviation degree between a current position of a vehicle and a training route, but the present disclosure is not limited thereto. For example, determiner 110 may compare a current position of vehicle 1 with a training route to determine whether the current position of vehicle 1 is outside the training route. In this case, for example, determiner 110 may simply determine whether the current position of vehicle 1 is outside the training route regardless of how the deviation degree between the current position and the training route is. Specifically, for example, even when vehicle 1 partially overlaps a training route, determiner 110 may determine that the current position of vehicle 1 is outside the training route, or in a case where vehicle 1 is located outside a training route, determiner 110 may determine that the current position of vehicle 1 is outside the training route.

Further, in the embodiment described above, the attention calling information is displayed on the display medium, but the present disclosure is not limited thereto. For example, information, such as information on deviation of a route, which a vehicle is traveling, from a training route and information on presence of an object close to a route to be traveled, may be outputted as the attention calling information by voice.

Further, in the embodiment described above, information for calling attention to a difference between a route to be traveled and a training route by performing emphasized display of the route to be traveled, by performing emphasized display of an object, or the like is outputted as the attention calling information, but the present disclosure is not limited thereto. For example, information for prompting the automatic parking control to be performed again, information for prompting the automatic parking control to be stopped, or the like may be outputted as the attention calling information.

In addition, any of the embodiment described above is only illustration of an exemplary embodiment for implementing the present disclosure, and the technical scope of the present disclosure shall not be construed limitedly thereby. That is, the present disclosure can be implemented in various forms without departing from the gist or the main features thereof.

While various embodiments have been described herein above, it is to be appreciated that various changes in form and detail may be made without departing from the spirit and scope of the invention(s) presently or hereafter claimed.

This application is entitled to and claims the benefit of Japanese Patent Application No. 2022-148062, filed on Sep. 16, 2022, the disclosure of which including the specification, drawings and abstract is incorporated herein by reference in its entirety.

### INDUSTRIAL APPLICABILITY

In automatic parking control, the parking assistance apparatus of the present disclosure is useful as a parking assistance apparatus and a parking assistance method each capable of improving a feeling of security of an occupant in a vehicle.

1. A parking assistance apparatus that performs parking assistance based on a training route of a vehicle in training traveling, the parking assistance apparatus comprising a processor that determines whether a current position of the vehicle is outside the training route based on the current position of the vehicle and the training route, wherein
the processor outputs, in a case where the current position of the vehicle is outside the training route, a command to notify an occupant in the vehicle.

2. The parking assistance apparatus according to claim 1, wherein the processor causes a display medium to display information on a route to be traveled by the vehicle in automatic parking control.

3. The parking assistance apparatus according to claim 2, wherein the processor causes the display medium to display the information on the route to be traveled in an aspect different from information on the training route of the vehicle in the training traveling.

4. The parking assistance apparatus according to claim 3, wherein the processor causes the display medium to display the information on the route to be traveled in a color different from a color of the training route of the vehicle in the training traveling.

5. The parking assistance apparatus according to claim 1, wherein:
the processor further determines a deviation degree between the current position of the vehicle and the training route, and
the processor outputs the command to notify the occupant in the vehicle in a case where a deviation amount between the current position of the vehicle and the training route is equal to or greater than a predetermined value.

6. The parking assistance apparatus according to claim 1, wherein the processor causes a display medium to display information on an object that is closer to a route to be traveled by the vehicle in automatic parking control than to the training route of the vehicle in the training traveling.

7. The parking assistance apparatus according to claim 1, wherein the processor outputs a command to lower a degree of attention calling to information on an object than the degree of attention calling prior to a change, the object being closer to the training route than to a route to be traveled by the vehicle in automatic parking control.

8. A parking assistance method of a parking assistance apparatus, the parking assistance apparatus performing parking assistance based on a training route of a vehicle in training traveling, the parking assistance method comprising:
determining whether a current position of the vehicle is outside the training route based on the current position of the vehicle and the training route; and
outputting, in a case where the current position of the vehicle is outside the training route, a command to notify an occupant in the vehicle.

9. The parking assistance method according to claim 8, wherein in the outputting, a display medium is caused to display information on a route to be traveled by the vehicle in automatic parking control.

10. The parking assistance method according to claim 9, wherein in the outputting, the display medium is caused to display the information on the route to be traveled in an aspect different from information on the training route of the vehicle in the training traveling.

11. The parking assistance method according to claim 10, wherein in the outputting, the display medium is caused to display the information on the route to be traveled in a color different from a color of the training route of the vehicle in the training traveling.

12. The parking assistance method according to claim 8, wherein:
in the determining, a deviation degree between the current position of the vehicle and the training route is further determined, and
in the outputting, the command to notify the occupant in the vehicle is outputted in a case where a deviation amount between the current position of the vehicle and the training route is equal to or greater than a predetermined value.

13. The parking assistance method according to claim 8, wherein in the outputting, a display medium is caused to display information on an object that is closer to a route to be traveled by the vehicle in automatic parking control than to the training route of the vehicle in the training traveling.

14. The parking assistance method according to claim 8, wherein in the outputting, a command to lower a degree of attention calling to information on an object than the degree of attention calling prior to a change is outputted, the object being closer to the training route than to a route to be traveled by the vehicle in automatic parking control.
